(19) United States
(12) Patent Application Publication
(10) Pub. No.: US 2024/0292200 A1
(43) Pub. Date: Aug. 29, 2024

(54) PROVISIONING OF A COMMUNICATION SERVICE OF A CONVEYOR SYSTEM

(71) Applicant: KONE Corporation, Helsinki (FI)

(72) Inventor: Otto PEKANDER, Helsinki (FI)

(73) Assignee: KONE Corporation, Helsinki (FI)

(21) Appl. No.: 18/656,683

(22) Filed: May 7, 2024

Related U.S. Application Data
(63) Continuation of application No. PCT/EP2021/081807, filed on Nov. 16, 2021.

(51) Int. Cl. H04W 4/80; H04W 4/30; H04W 12/06

(52) U.S. Cl. CPC H04W 4/80; H04W 4/30; H04W 12/06

(57) ABSTRACT

A method for provisioning a communication service of a conveyor system, performed by a controller, includes: receiving data from a terminal device over a short-range wireless communication connection; performing an authentication procedure of the terminal device; and generating, in response to a successful authentication procedure of the terminal device, a control signal to activate the communication service of the conveyor system for providing access to a data network over the communication service of the conveyor system. A controller, a computer program, and a conveyor system are also described.

### TECHNICAL FIELD

The invention concerns in general the technical field of conveyor systems. More particularly, the invention concerns provisioning of a communication service in conveyor systems.

### BACKGROUND

Buildings having a conveyor system, such as an elevator, are built by following safety norms and requirements and as a result the structure of the building, or at least part of it, becomes so solidly built that it limits, or even blocks, electromagnetic radiation. Such parts of the building may e.g. be an elevator shafts, or machine rooms of the conveyor systems, which may e.g. reside in the bottom floor of the building or even in cellars of the building. When the electromagnetic radiation is limited, or blocked, e.g. in the mentioned parts of the building it has an effect on communication in wireless manner when the network coverage comes from external sources, such as from a mobile communication networks.

It is commonly known that there is developed some approaches to extend wireless coverage with additional devices. Such devices may be different types of extenders e.g. for extending a coverage of a mobile communication network, but also by adding additional antennas, wave guides, or similar to locations which increase a coverage of the respective network in challenging communication environments. The disadvantage of such solutions is that they are typically expensive to implement, especially if the connections are rarely used.

On the other hand when considering a need of the network coverage in the mentioned parts of the buildings they are typically needed especially by a technician entering the buildings. The technician may need to transmit measurement data or similar to a data centre but also to download data, such as software and instructions for performing a maintenance work. If a needed network coverage is not available in the space of the maintenance operation, it becomes challenging and time-consuming if the technician needs to leave the space when needing the network coverage and the re-entering the space to continue the maintenance work.

Hence, there is room to introduce novel approaches for providing the network coverage in the conveyor system environment.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a controller, a computer program, and a conveyor system for provisioning a communication service.

The objects of the invention are reached by a method, a controller, a computer program, and a conveyor system as defined by the respective independent claims.

According to a first aspect, a method for provisioning a communication service of a conveyor system is provided, the method, performed by a controller, comprises:
receiving data from a terminal device over a short-range wireless communication connection,
performing an authentication procedure of the terminal device based on data received over the short-range wireless communication connection,
generating, in response to a successful authentication procedure of the terminal device, a control signal to activate the communication service of the conveyor system for providing access to a data network over the communication service of the conveyor system.

The authentication procedure of the terminal device may comprise a step of exchanging a number of authentication keys between the terminal device and the controller at least in part over the short-range wireless communication connection. For example, the number of authentication keys may be received at least by the controller upon a receipt of information indicating that the terminal device resides in a predefined location.

The method may further comprise: transmitting, in response to the successful authentication procedure of the terminal device, data for accessing the communication service of the conveyor system activated in response to the successful authentication procedure. For example, the data for accessing the communication service of the conveyor system may comprise an access code.

The method may further comprise: polling the presence of the terminal device over the short-range wireless communication connection. For example, a control signal to inactivate the communication service of the conveyor system may be generated in response to a detection that the terminal device is not present.

A control signal may also be generated to activate the short-range wireless communication connection upon a receipt of information indicating that the terminal device resides in a predefined location.

According to a second aspect, a controller for provisioning a communication service of a conveyor system is provided, the controller is configured to:
receive data from a terminal device over a short-range wireless communication connection,
perform an authentication procedure of the terminal device based on data received over the short-range wireless communication connection,
generate, in response to a successful authentication procedure of the terminal device, a control signal to activate the communication service of the conveyor system for providing access to a data network over the communication service of the conveyor system.

The controller may be configured to perform the authentication procedure of the terminal device by exchanging a number of authentication keys between the terminal device and the controller at least in part over the short-range wireless communication connection. For example, the controller may be configured to receive the number of authentication keys upon a receipt of information indicating that the terminal device resides in a predefined location.

The controller may further be configured to: transmit, in response to the successful authentication procedure of the terminal device, data for accessing the communication service of the conveyor system activated in response to the successful authentication procedure. For example, the controller may be configured to include an access code to the data for accessing the communication service of the conveyor system.

The controller may further be configured to: poll the presence of the terminal device over the short-range wireless communication connection. For example, the controller may be configured to generate a control signal to inactivate the communication service of the conveyor system in response to a detection that the terminal device is not present.

The controller may also be configured to generate a control signal to activate the short-range wireless communication connection upon a receipt of information indicating that the terminal device resides in a predefined location.

For example, the controller may be a controller of the conveyor system, such as an elevator controller.

According to a third aspect, a computer program is provided the computer program comprising computer readable program code configured to cause performing of the method according to the first aspect as defined above when the computer readable program code is run on one or more computing apparatuses.

According to a fourth aspect, a conveyor system is provided the conveyor system comprising a controller according to the second aspect as defined above.

For example, the conveyor system may be one of: an elevator system, an escalator, a moving walkway.

An access to a data network over a communication service of the conveyor system may be arranged from one of: an elevator shaft, a machine room of the conveyor system.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a conveyor system according to an example.

FIG. 2 illustrates schematically a method according to an example.

FIG. 3 illustrates schematically an apparatus according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

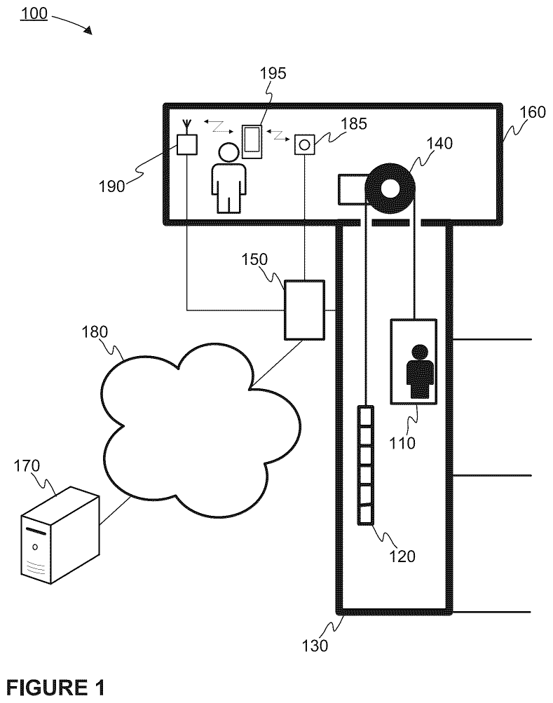

FIG. 1 illustrates schematically an example of an environment into which the present invention may be implemented to. The environment is a conveyor system 100 which in the context of the non-limiting example as illustrated in FIG. 1 is an elevator system. The elevator system may be so-called counter-weight elevator wherein an elevator car 110 arranged to travel in an elevator shaft 130 between floors is balanced with a counter-balance 120. The force for causing the travel of the elevator car 110 is received from a machinery 140 of the elevator system which machinery 140 may e.g. comprise an electrical motor configured to generate a force to rotate a traction sheave over which an elevator rope is arranged to travel. The machinery also comprises elevator brakes among other entities. The conveyor system 100 is controlled with a controller 150 communicatively connected to at least some entities of the conveyor system 100 wherein the controller 150 is configured to take care of at least some of control functions of the conveyor system either alone or together with one or more sub-controllers. The controller 150 may also be communicatively connected to one or more network nodes 170 over a communication network 180 wherein the network nodes 170 may be configured to implement operations of a data centre of the conveyor system 100 e.g. in a cloud type of computing environment. The communication network 180 may e.g. refer to a data network, such as Internet, but also to one or more mobile communication networks. For the purpose of describing at least some aspects of the present invention it is hereby assumed that the conveyor system 100 comprises a space 160 built so that an access of an electromagnetic radiation from outside, such as from mobile communication networks, is limited, or even blocked, to the space 160 due to constructional reasons. The space 160 may refer to a machine room having such outer structure which limits the propagation of the electromagnetic radiation inside, but a network coverage is needed therein e.g. for a purpose of maintenance operation when a technician enters the space 160. The present invention does not take any limiting standpoint to a location of the space 160 of the conveyor system 100 in the building, or premises, the conveyor system 100 resides.

In accordance with the present invention the conveyor system 100 is equipped with further devices in order to provide a wireless communication connection in the space 160 of the conveyor system 100. In the non-limiting example as illustrated in FIG. 1 the devices are depicted as separate entities referred with 185 and 190 but their functionalities may be integrated to a single device. The first entity 185 is a device configured to perform a short-range wireless communication with another communicating entity as is described in the forthcoming description. The first entity 185 may be communicatively connected to the controller 150 e.g. over a wired connection arranged through the structure of the space 160 and in such a way to establish a short-range wireless communication interface to the controller 150. The short-range wireless communication technology implemented by the first entity 185 may e.g. be Bluetooth, Near-field communication (NFC), infrared (IR), ZigBee, or any similar short-range wireless communication technology over which it is possible to transfer a limited amount of data and the coverage is short in nature which may also be utilized for determining a position of the other communicating entity with the first entity 185 in a predefined accuracy.

Moreover, the conveyor system 100 may be equipped with second entity 190 configurable to provide a wireless communication network in the space 160, or at least in a part of the space 160. The second entity may also be communicatively connected to the controller 150 of the conveyor system 150 and in such a way to establish a communication interface to access the communication service of the conveyor system 100. The second entity may e.g. be a base station configured to implement a wireless local area network technology providing a high throughput communication technology according to Wi-Fi, for example. In other words, the second entity 190 may provide a wireless communication network for accessing the network node 170 over the data communication network 180 in order to exchange of data.

In order to save energy and limit any security risks the second entity 190 is set to an inactive mode which may refer to an idle mode and/or to a switch off mode. The activation of the respective second entity 190 may be performed by triggering it from the controller 150 in a predefined manner. The inactive mode of the second entity 190 corresponds to a state in which the device does not generate the wireless communication network or at least any access to the wireless communication network is prevented in the inactive mode.

Now, a person, such as a technician, may enter the space 160 and carry a terminal device 195 with her/him. The terminal device 195 is advantageously such that it is capable of implementing the same communication technology as the first entity 185 and the same communication technology as the second entity 190. For example, the terminal device 195 may be a mobile phone, a tablet computer, a laptop, a dedicated maintenance device, or any other similar device which may be configured to implement the communication technologies as mentioned, but it may also comprise further communication interfaces, such as those which enable a communication with mobile communication networks when such network coverage is available. The terminal device 195 may also be involved in a maintenance operation of the conveyor system e.g. over the communication interface of either the first entity 185 or the second entity 190, or any other further interface being wireless or wired. In any case the terminal device 195 is equipped with a communication interface implementing the communication technology of the first entity 185, which may refer to the Bluetooth, the Near-field communication (NFC), the infrared (IR), the ZigBee, or any similar short-range wireless communication technology. The communication interface may be established in the terminal device 195 with a dedicated circuit configured to implement such a communication technology. Correspondingly, the terminal device 195 is also equipped with a communication interface implementing the communication technology of the second entity 190, i.e. the Wi-Fi technology capable of high throughput of data.

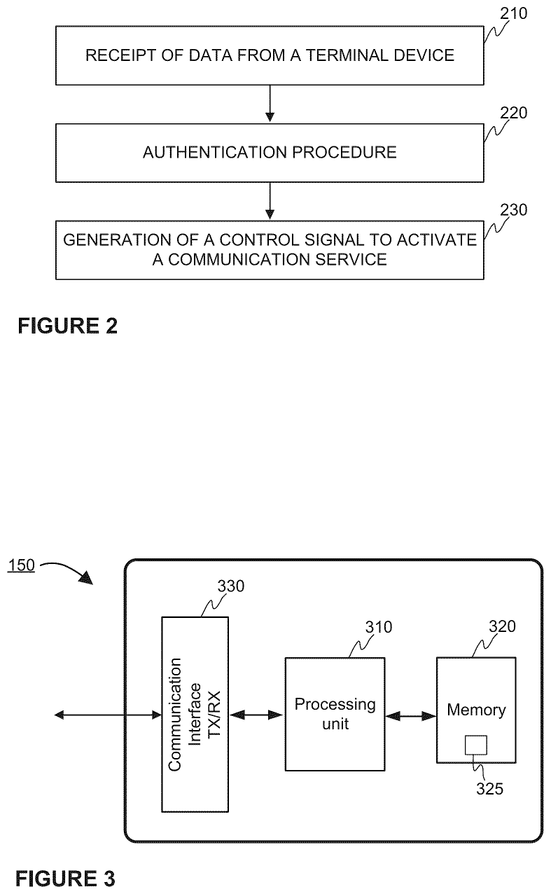

Some further aspects of the present invention is now described by referring to FIG. 2 schematically illustrating a method according to an example. Upon entering the space 160 the user of the terminal device 195, i.e. the technician, may come close to the first entity 185 so that the terminal device 195 is in an operational vicinity to the first entity 185 so as to allow a communication over the short-range wireless communication technology implemented by the first entity 185 and the terminal device 195, respectively. In order to initiate the communication the terminal device 195 may be set to such a state that it automatically initiates the wireless communication or the initiation of the communication may require one or more predefined operations e.g. from the user of the terminal device 195, such as an activation of the respective communication interface from the terminal device 195, an activation of an application related to the communication with the short-range wireless communication technology and/or with the first entity 185, an interaction with an application related to the communication with the first entity 185, moving the terminal device 195 close to the first entity 185 (cf. NFC) to initiate the communication, and so on. Hence, in response to required preparations, if any, the terminal device 195 and the first entity 185 may initiate the wireless communication with the short-range wireless communication technology applied therein.

The establishment of the wireless communication channel between the mentioned entities allows exchanging of data. In accordance with the present invention the exchange of the data may comprise that security related pieces of data are transferred from a memory of the terminal device 195 to the controller 150 through the first entity 185 providing the short-range wireless communication interface in the space 160, the first entity 185 being communicatively connected to the controller 150. The security related pieces of data may refer to a number of authentication keys based on which an authentication procedure of the terminal device 195 may be performed. In other words, the controller 150 receives 210 data from the terminal device 195 wherein the data comprises at least security related pieces of data, such as the number of the authentication keys. The transfer of the data may be arranged to be user controllable for example so that the user is prompted to provide an acceptance to the transfer of the data during the established short-range wireless communication. Alternatively or in addition, the user may be requested to provide credentials, such as a username and a password, to an application in order to accept the transfer of the security relate data from the terminal device 195 to the controller 150. In this manner a security of the overall solution in accordance with the present invention may be improved.

In response to that the controller 150 receives 210 the data in a predefined format and comprising predefined security related pieces of data the controller 150 is configured to perform 220 an authentication procedure of the terminal device 195 based on at least part of the data received over the short-range wireless connection wherein the at least part of the data comprises predefined security related pieces of data, such as the number of the authentication keys. For example, the authentication keys may be related to the known authentication model based on a combination of a public key and a secret key wherein an exchange of a public key allows an authentication procedure with the secret key.

Next, the controller 150 configured to perform 220 the authentication procedure may generate a detection result indicative of an outcome of the authentication procedure. In case the authentication procedure indicates that the terminal device 195 is not authenticable on the basis of the received data the controller 150 may be arranged to operate in a predefined manner. According to a first example the controller 150 may be configured to take no further actions i.e. the interaction of the terminal device 195 over the short-range wireless communication interface does not cause any actions. In a more sophisticated operation the controller 150 may be configured to generate a control signal causing a disconnection of the wireless communication connection between the terminal device 195 and the first entity 185. The disconnection may e.g. be achieved by inactivating the first entity 185 e.g. by switching it off or preventing an establishment or a maintenance of any wireless communication to and from it. In some further embodiments the controller 150 may also be configured to generate an alarm signal e.g. to the data centre in order to inform that an unauthenticated person has accessed the space in question 160 so as to cause any further operations, such as sending a guard to the premises and the space to check the situation.

On the other hand, if the authentication procedure is successful, i.e. the entity, such as the controller 150, configured to perform the authentication is able to authenticate the terminal device 195 based on the received data, the entity is configured to generate 230 a control signal to activate a communication service of the conveyor system 100 for providing access to a data network 180 over the communication service of the conveyor system 100. The activation of the communication service may be achieved by activating the second entity 190 to perform its operation of generating a wireless local area network as the communication service in the space 160. As a non-limiting example of the control signal it may be a wake-up signal to the second entity 190 to set the device to an active mode from the idle mode. Alternatively or in addition, the control signal may switch on the device so as cause the second entity 190 to generate the wireless network coverage with the wireless local area network technology. Moreover, in some example embodiments the controller 150 may also be configured to inform the network node 170 on that the technician is in the premises, i.e. in the space 160.

For sake of clarity it is worthwhile to mention that the communication service of the conveyor system 100 refers to a communication service implemented for the conveyor system e.g. to communicate with the network node 170 configured to implement a role of a data centre. Such a communication service is by definition not available, or open, to other parties, but the present invention introduces a way to provide the access in a secure manner.

In some example embodiments the controller 150 may be provided with an access to data associating the first entity 185 and the second entity 190 together in order to cause an activation of the communication service in a correct space 160. This may be arranged so that the data received from the terminal device 195 through the first entity 185 identifies the first entity 185 in some manner to the controller 150. This may e.g. be achieved so that the first entity 185 adds its identifier to the data received from the terminal device 195 and in that manner the identification of the first entity 185 may be received by the controller 150. Alternatively, the first entity 185 may indicate its identity in a separate signaling. The controller 150 may then utilize the data identifying the first entity 185 so that it uses the data for inquiring information on the second entity 190 from data storage implemented e.g. as a database. In response to the inquiry the controller 150 may possess the data identifying the second entity 190 e.g. with any further information, such as a network address of the second entity 190, and the controller 150 may generate 230 the control signal to activate the second entity 190. In some other embodiments, the association of the first entity 185 and the second entity 190 may be established through identifying a location of the terminal device 195 based on the short-range wireless communication with the first entity 185, and, hence, based on the known location of the first entity 185, and by applying the location information the controller 150 may inquiry the second entity 190, or a plurality of the second entities 190, with the same location in a predefined accuracy.

Now, the second entity 190 is arranged to provide the communication service to the terminal device 195 wherein the terminal device 195 may connect itself to the wireless local area network in the space 160 and wherein the access to the data network 180, and to the network node 170, may be provided to the terminal device 195 by utilizing the communication connection of the conveyor system 100. The access to the communication service by the terminal device 195 may be arranged to occur automatically or manually. For example, since the terminal device 195 of the technician may be managed by the entity allowed to have access to maintain the conveyor system 100, the respective entity may have prepared the terminal device 195, e.g. by defining the wireless network in the space 160 in a required manner, such as by storing a password, to access the network, and upon a detection of the wireless network in the space 160 by the terminal device 195 an access to it may occur by using the stored password in the access. It may also be implemented so that the technician is aware of the password, or similar, of the wireless network and he/she may connect to the network by selecting the network with the terminal device 195 and provide the password upon an inquiry of it by the terminal device 195. For sake of clarity it is worthwhile to mention that upon the access to the data network over the communication service of the conveyor system 100 the user of the terminal device 195 may receive and transmit data from and to the data network, such as Internet if it is not prohibited and the only access is to the network node 170 over the data network.

According to an example embodiment a safety of the system may be improved by arranging the controller 150, upon a successful authentication in the step 220 of FIG. 2, to deliver access code, such as a password, to the terminal device 195 in order to access the wireless communication network provided by the second entity 190. The delivery of the access code to the terminal device 195 may be implemented by utilizing the short-range wireless communication connection established between the first entity 185 and the terminal device 195. Upon the receipt of the access code the technician may check it from the message received by the terminal device 195 and input it when selecting the wireless network for accessing. In a further sophisticated embodiment the controller 150 may generate a new access code for the wireless network generated by the second entity 190 upon the successful authentication of the terminal device 195 and set that to the second entity 190 with a control signal. Now, the same generated access code may be delivered to the terminal device 195 in any of the described manner and, hence, the terminal device 195 may access to the wireless network generated by the second entity 190 in any of the manners as described. Still further, the access code, or the access of the terminal device 195 to the wireless network, may be set to be time limited e.g. so that the validity time of the access code is time limited. These kinds of approaches improve the security since the delivery of the access code and the validity of the access code may be controlled in a desired manner. The access code may be a password or any other kind of access credentials.

In some further example embodiments a security of the conveyor system, and especially the security to the access to the communication service of the conveyor system 100, may be improved by utilizing the short-range wireless communication connection between the terminal device 195 and the first entity 185. The utilization of the short-range wireless communication connection may be performed so that the control system 150 is configured to transmit a polling signal to the terminal device 195 over the first entity 185 in order to confirm that the terminal device 195 resides in an operational vicinity of the first entity 185 in the space 160. Upon a detection that the terminal device 195 does not respond to the polling, which may be interpreted as an indication that the terminal device 195 does not reside in the space 160 anymore, the control system 150 may be configured to generate another control signal to the second entity 190 to inactivate the communication service of the conveyor system 100. In this manner it may be prevented that any other person entering the space 160 after the technician has left the space 160 cannot utilize the communication service even if possesses an access code or even if the communication service is configured not to require any access codes.

In the foregoing description of the at least some aspects of the present invention it is assumed that the short-range wireless communication connection over the first entity 185 is mainly used for transferring security related data for performing the authentication procedure. The same short-range wireless communication connection may be used for indicating the controller 150 a need for the communication service of the conveyor system 100 wherein the indication may be performed with the terminal device 195. The indication may be performed either prior performing any authentication procedure or after the authentication procedure. This triggers either the authentication procedure or if it is already done it triggers the generation of the control signal to activate the communication service. This kind of approach serves a situation in which the user of the terminal device 195, i.e. the technician, may select an instant of time for the communication service if any.

In a still further example embodiment the operation may be more controllable from a point of view of the maintenance operation and the data centre. Namely, the maintenance work is assigned to the technician from a service centre of the conveyor systems which may be represented with the network node 170 in FIG. 1. Now, when the technician is travelling to the premises of the conveyor system 100 the location of the technician may be monitored through a location of the terminal device 195 by utilizing a commonly known positioning system, such as a satellite-based positioning system or a mobile communication network based positioning system. In response to a detection that the technician is in a predefined location, such as within a predefined distance from the premises or the building, or in the premises, the network node 170 may be configured to deliver predetermined type of data to the controller 150 wherein the predetermined type of data may be data used for an authentication of the terminal device 195. For example, the data may be an authentication key corresponding to the data stored in the terminal device 195 the user, such as the other part of the key pair, which the controller 150 may utilize in the authentication of the data received from the terminal device 195 over the short-range wireless communication connection. In some example embodiments, the network node 170 may also be configured to deliver the authentication data, such as an authentication key, to the terminal device 195 over a mobile communication network servicing the terminal device 195 prior to entering the space 160. The described approaches improve the security since it is possible to control case-by-case who are allowed to utilize the communication service of the conveyor system 100.

Alternatively or in addition, upon the detection that the terminal device 195, and, thus, the technician, resides in a predefined location, such as in the predefined distance from the space 160, the controller 150 may be configured to activate the first entity 185 to prepare it to the short-range wireless communication with the terminal device 195 when the terminal device 195 enters the space 160 in question. This also improves the security since the first entity 185 is not always available.

For sake of clarity it is worthwhile to mention that the predefined location triggering the delivery of data to the controller 150 and/or the terminal device 195 is not necessarily the same as the predefined location triggering the activation of the first entity and they be separately selected in accordance with a need, such as depending on the size of the premises and based on any other factors.

In the foregoing description at least some aspects of the invention are described with an implementation in which the controller of the conveyor system 100 is executing the role of the controller 150 for provisioning the communication service of the conveyor system to the terminal device 195 in the described manner. However, it may also be arranged that another apparatus is configured to take the role of managing the provision of the communication service at least in part e.g. together with the controller of the conveyor system 100 which takes the overall control of the operation of the conveyor system 100 and entities therein. For example, the apparatus may be configured to perform the authentication related operations as well as a generation of an access codes if such an implementation is made.

FIG. 3 illustrates schematically an example of an apparatus configurable to implement the present invention at least in part. The apparatus of FIG. 3 may e.g. be configured to perform a function of the controller 150 as described so as to manage the provisioning of the communication service. For sake of clarity, it is worthwhile to mention that the block diagram of FIG. 3 depicts some components of an entity that may be employed to implement a functionality of the apparatus. The apparatus comprises a processor 310 and a memory 320. The memory 320 may store data, such pieces of data as described, but also computer program code 325 causing the management of the provisioning of the communication service in the described manner. The apparatus may further comprise a communication interface, such as a wireless communication interface or a communication interface for wired communication, or both to communicate with other entities of the conveyor system 100. The communication interface may thus comprise one or more modems, antennas, and any other hardware and software for enabling an execution of the communication e.g. under control of the processor 310. Furthermore, I/O (input/output) components may be arranged, together with the processor 310 and a portion of the computer program code 325, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include out-put means, such as a loudspeaker, a display, or a touchscreen. The components of the apparatus may be communicatively connected to each other via data bus that enables transfer of data and control information between the components.

The memory 320 and a portion of the computer program code 325 stored therein may further be arranged, with the processor 310, to cause the apparatus to perform at least a portion of a method for managing the provisioning of the communication service as is described herein. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some, or all of which may be integrated/removable and/or may provide permanent/semi-permanent/dynamic/cached storage.

The computer program code 325 may comprise computer-executable instructions that implement functions that correspond to steps implemented in the provisioning of the communication service when loaded into the processor 310 of the controller 150. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus to perform a method as explicitly described herein. Hence, the apparatus may comprise at least one processor 310 and at least one memory 320 including the computer program code 325 for one or more programs, the at least one memory 320 and the computer program code 325 configured to, with the at least one processor 310, cause the apparatus to perform the method.

The computer program code 325 may be provided e.g. a computer program product comprising at least one computer-readable non-transitory medium having the computer program code 325 stored thereon, which computer program code 325, when executed by the processor 310 causes the apparatus to perform the method. The computer-readable non-transitory medium may comprise a memory device or a record medium such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the entity performing the method may also be implemented with a plurality of apparatuses, such as the one schematically illustrated in FIG. 3, as a distributed computing environment corresponding to a control system. For example, one of the apparatuses may be communicatively connected with other apparatuses, and e.g. share the data of the method, to cause another apparatus to perform at least one portion of the method. As a result, the method performed in the distributed computing environment generates the detection result as described.

Some aspects of the invention may relate to a conveyor system comprising the entities as described and configured to implement the method as described in the foregoing description.

For sake of clarity it is hereby mentioned that even if the invention is described in the foregoing description mainly by referring that the conveyor system 100 is an elevator system it is not anyhow limited to that. The conveyor system 100 may also be an escalator or a moving walkway wherein a specific space 160 exists into which there is a need to establish a communication service, and a wireless communication network, in a secure manner.

The specific examples provided in the description given above should not be construed as limiting the applicability and/or the interpretation of the appended claims. Lists and groups of examples provided in the description given above are not exhaustive unless otherwise explicitly stated.

1. A method for provisioning a communication service of a conveyor system, the method, performed by a controller, comprises:
receiving data from a terminal device over a short-range wireless communication connection;
performing an authentication procedure of the terminal device based on data received over the short-range wireless communication connection; and
generating, in response to a successful authentication procedure of the terminal device, a control signal to activate the communication service of the conveyor system for providing access to a data network over the communication service of the conveyor system.

2. The method of claim 1, wherein the authentication procedure of the terminal device comprises a step of exchanging a number of authentication keys between the terminal device and the controller at least in part over the short-range wireless communication connection.

3. The method of claim 2, wherein the number of authentication keys is received at least by the controller upon a receipt of information indicating that the terminal device resides in a predefined location.

4. The method of claim 1, the method further comprises:
transmitting, in response to the successful authentication procedure of the terminal device, data for accessing the communication service of the conveyor system activated in response to the successful authentication procedure.

5. The method of claim 4, wherein the data for accessing the communication service of the conveyor system comprises an access code.

6. The method of claim 1, the method further comprises:
polling the presence of the terminal device over the short-range wireless communication connection.

7. The method of claim 6, wherein a control signal to inactivate the communication service of the conveyor system is generated in response to a detection that the terminal device is not present.

8. The method of claim 1, wherein a control signal is generated to activate the short-range wireless communication connection upon a receipt of information indicating that the terminal device resides in a predefined location.

9. A controller for provisioning a communication service of a conveyor system, the controller is configured to:
receive data from a terminal device over a short-range wireless communication connection;
perform an authentication procedure of the terminal device based on data received over the short-range wireless communication connection; and
generate, in response to a successful authentication procedure of the terminal device, a control signal to activate the communication service of the conveyor system for providing access to a data network over the communication service of the conveyor system.

10. The controller of claim 9, wherein the controller is configured to perform the authentication procedure of the terminal device by exchanging a number of authentication keys between the terminal device and the controller at least in part over the short-range wireless communication connection.

11. The controller of claim 10, wherein the controller is configured to receive the number of authentication keys upon a receipt of information indicating that the terminal device resides in a predefined location.

12. The controller of claim 9, the controller further configured to:
transmit, in response to the successful authentication procedure of the terminal device, data for accessing the communication service of the conveyor system activated in response to the successful authentication procedure.

13. The controller of claim 12, wherein the controller is configured to include an access code to the data for accessing the communication service of the conveyor system.

14. The controller of claim 9, the controller further configured to:
poll the presence of the terminal device over the short-range wireless communication connection.

15. The controller of claim 14, wherein the controller is configured to generate a control signal to inactivate the communication service of the conveyor system in response to a detection that the terminal device is not present.

16. The controller of claim 9, wherein the controller is configured to generate a control signal to activate the short-range wireless communication connection upon a receipt of information indicating that the terminal device resides in a predefined location.

17. The controller of claim 1, wherein the controller is a controller of the conveyor system.

18. A computer program embodied on a non-transitory computer readable medium and comprising computer readable program code configured to cause performing of the method according to claim 1 when the computer readable program code is run on one or more computing apparatuses.

19. A conveyor system comprising the controller according to claim 9.

20. The conveyor system of claim 19, wherein the conveyor system is one of: an elevator system, an escalator, a moving walkway.

21. The conveyor system of claim 1, wherein an access to a data network over a communication service of the conveyor system is arranged from one of: an elevator shaft, a machine room of the conveyor system.
